(19) United States
(12) Patent Application Publication
(10) Pub. No.: US 2005/0251459 A1
(43) Pub. Date: Nov. 10, 2005

(54) System and method for buying goods using number based domain and mobile internet

(76) Inventors: Hoon-Bae Kim, Seoul (KR); Gap-Chun Back, Uijeongbu-si (KR); Kang-Suk Woo, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/110,515

(22) Filed: Apr. 20, 2005

Related U.S. Application Data
(63) Continuation of application No. PCT/KR03/00170, filed on Jan. 27, 2003.

(30) Foreign Application Priority Data
Oct. 21, 2002 (KR) 10-2002-0064321

(51) Int. Cl. G06F 17/60

(52) U.S. Cl. 705/26

(57) ABSTRACT

A system and method for buying goods using a number based domain and the mobile Internet are disclosed. In one embodiment, the system extracts a shopping mall code from number domain information received from a user terminal. Then, if the extracted shopping mall code exists in a pre-stored shopping mall list, the system connects the user terminal to a shopping mall server via a network, by retrieving a character domain corresponding to the shopping mall code and transmitting purchasing request information to the shopping mall server. Thereby, the connection process of a shopping mall site and the selection process of purchasing goods can be simplified without adding a new system and creating mobile content.

### RELATED APPLICATIONS

This application is a continuation application, and claims the benefit under 35 U.S.C. §§ 120 and 365 of PCT Application No. PCT/KR2003/00170, filed on Jan. 27, 2003 and published on Apr. 29, 2004, in English, which is hereby incorporated by reference.

### BACKGROUND OF THE INVENTION

1. Technical Field

The present invention relates to a system and a method for buying goods using a number based domain and the mobile Internet and more specifically, to a system and a method for simplifying the process of connecting to a shopping mall site and selecting goods using a wireless number based domain function provided by a conventional user terminal without requiring an additional new system or new wireless content.

2. Description of the Related Technology

A user terminal such as a cellular phone or a personal digital assistant (PDA) having limitation on size of liquid crystal display (LCD) requires additional wireless content to be displayed. But, up to now, wireless content having suitable level is short compared with a supply rate of user terminals.

Such problems also fall in the mobile shopping over the wireless Internet. When buyers do mobile shopping using a user terminal, the process is too involved to select desire goods because the buyer's environment is inappropriate.

### SUMMARY OF CERTAIN INVENTIVE ASPECTS

One aspect of the present invention provides a system and method for simplifying the process of connecting to a shopping mall site and selecting goods using a wireless number based domain function provided by a conventional user terminal without requiring an additional new system or new wireless content.

Another aspect of the present invention provides a system and a method for securely purchasing goods by the secure transmission of buyer's payment information.

Another aspect of the present invention provides a method of buying goods using a number based domain and the wireless Internet provided through a user terminal, said method comprising: receiving a number domain information entered by a buyer from the user terminal; generating purchasing request information (for example, it may comprise a goods code and a telephone number of a buyer) using the number domain information; extracting a shopping mall code from the number domain information; determining whether or not the shopping mall code exists in a shopping mall list pre-stored in a database; retrieving a text domain when the shopping mall code exists in the shopping mall list; and transmitting the purchasing request information to a shopping mall server corresponding to a shopping mall site corresponding to the text domain. In addition, a system, an apparatus and a computer-readable medium for enabling the above method for buying goods using number based domain and wireless Internet provided through a user terminal to be executed are provided.

In one embodiment, the method further comprises interconnecting the shopping mall server and the user terminal through the network, in order that information is transmitted and received between the user terminal and the shopping mall server through the network.

In one embodiment, the extracting the shopping mall code from the number domain information may be performed using a predetermined method by extracting at least one number data in a predetermined field as a shopping mall code.

In one embodiment, the extracting the shopping mall code from the number domain information may be performed by extracting information in a predetermined field on the basis of a location of an identifier as the shopping mall code if the identifier (for example, a predetermined mark or a predetermined character) is included for respectively dividing code information in the number domain information.

In one embodiment, the number domain information may be retrieved through the shopping mall site or downloaded to the user terminal.

In one embodiment, the shopping mall server performs: pre-storing at least one goods information corresponding to at least one goods code; receiving the purchasing request information (for example, it may comprise a goods code and a telephone number of the buyer); determining whether or not the goods information corresponding to the goods code exists; transmitting a predetermined error message to the user terminal when the goods information corresponding to the goods code does not exist; determining whether or not a buyer information corresponding to the telephone number exists when the goods information corresponding to the goods code exists; transmitting, when the buyer information exists, a payment request information to a first payment system corresponding to a first payment information (for example, it may comprise at least any one of credit card information, telephone number information for billing total service charge along with a mobile communication service charge, and ARS billing information) included in the buyer information; transmitting, when the buyer information does not exist, a payment information request to the user terminal; receiving a second payment information corresponding to the payment information request from the user terminal; and transmitting a payment request information to a second payment system corresponding to the second payment information.

In one embodiment, the method, when the buyer information exists and the first payment information included in the buyer information is the credit card information, may further comprise: transmitting an entry request relating to at least any one of a password and a validity period corresponding to the credit card information to the user terminal; and receiving the entry information relating to at least any one of the password and the validity period from the user terminal.

### BRIEF DESCRIPTION OF THE DRAWINGS

FIG. 1 is a schematic diagram of a system for executing a goods purchase process using a number based domain and the wireless Internet in accordance with one embodiment of the present invention.

FIG. 2 illustrates a data flow for purchasing goods using a number based domain and the wireless Internet in accordance with one embodiment of the present invention.

FIG. 3 illustrates a flowchart for the operation executed by a domain address converting server and a mobile service apparatus in a goods purchase process using a number based domain and the wireless Internet in accordance with one embodiment of the present invention.

FIG. 4 illustrates a screen display at entering number domain information in a goods purchase process using a number based domain and the wireless Internet in accordance with one embodiment of the present invention.

FIG. 5 is an entire schematic diagram of a system for executing a goods purchase process using a number based domain and the wireless Internet in accordance with another embodiment of the present invention.

FIG. 6 illustrates a screen display at entering number domain information in a goods purchase process using a number based domain and the wireless Internet in accordance with another embodiment of the present invention.;

FIG. 7 illustrates a screen display at entering number domain information in a goods purchase process using a number based domain and the wireless Internet in accordance with still another embodiment of the present invention;

FIG. 8 illustrates a screen display at selecting purchase method in a goods purchase process using a number based domain and the wireless Internet in accordance with one embodiment of the present invention;

FIG. 9 illustrates a screen display at receiving a payment completion message in a goods purchase process using a number based domain and the wireless Internet in accordance with one embodiment of the present invention.

### DETAILED DESCRIPTION OF CERTAIN INVENTIVE EMBODIMENTS

One embodiment of the present invention provides convenience to buyers by simplifying the process with transmitting only number domain information instead of transmitting a shopping mall address and goods information separately to conduct two processes including connecting to a shopping mall site and selecting goods, in order to purchase goods.

Hereinafter, embodiments of the present invention will be described with reference to the attached drawings

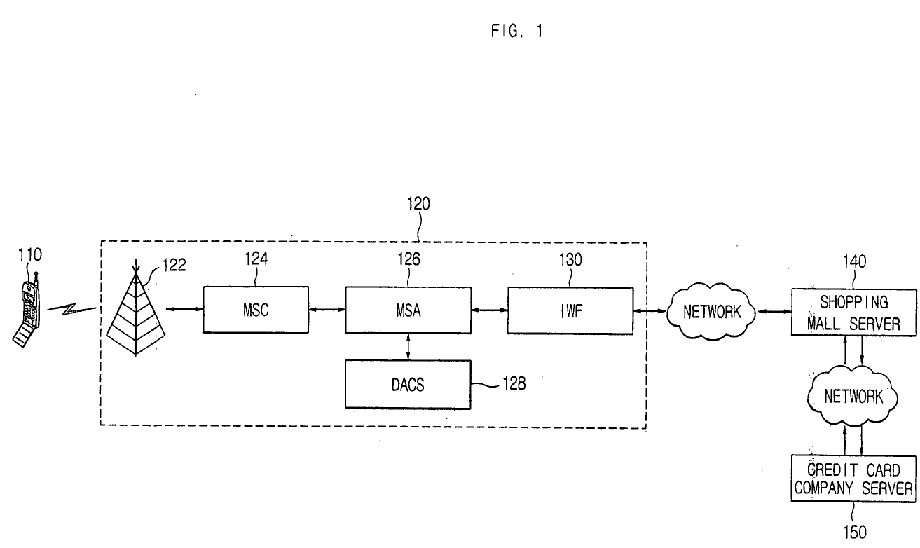

FIG. 1 is an entire schematic diagram of a system for executing a goods purchase process using a number based domain and the wireless Internet in accordance with one embodiment of the present invention.

In one embodiment, the system of FIG. 1 comprises a user terminal 110, a mobile telecommunication service system 120, a shopping mall server 140, a credit card company server 150 and the like.

The user terminal 110 transmits number domain information entered by a buyer to a Base Transceiver Station (BTS) 122, and receives shopping mall site information corresponding to the number domain information from the BTS 122.

The user terminal is any one of a mobile phone executing wireless Internet service function, a personal digital assistant (PDA), a notebook computer and the like.

The mobile telecommunication service system 120 comprises the BTS 122, a Mobile Switching Center (MSC) 124, a mobile service apparatus 126, a domain address converting server 128, an IinterWorking Function (IWF) 130 and the like, and provides wireless Internet service and mobile telecommunication service to conduct the goods purchase process.

The BTS 122 receives the number domain information from the user terminal 110, transmits the number domain information to the MSC 124, receives the shopping mall information corresponding to the number domain information from MSC 124, and transmits the shopping mall information to the user terminal 110.

The MSC 124 receives the number domain information from the BTS 122, transmits the number domain information to the mobile service apparatus 126 (hereinafter referred as to MSA 126), receives data corresponding to the number domain information from the MSA 126, and transmits the data to the BTS 122.

The MSA 126 transmits the number domain information received through the MSC 124 to the domain address converting server 128 (hereinafter referred as to DACS 128), receives text domain information converted correspondingly to the number domain information from the MSC 124, and transmits the text domain information to the IWF 130.

In addition, the MSA 126 generates purchasing request information using the number domain information and transmits the generated purchasing request information to the IWF 130.

The DACS 128 extracts a shopping mall code from the number domain information when the number domain information is received from the MSA 126, converts the number domain information into a text domain address, and transmits the text domain address to the MSA 126.

The functions such as creating purchase request information, converting into text domain using number domain information, transmitting and receiving wireless data and the like executed by the MSA 126 and DACS 128 can be executed by one apparatus covering the functions of the MSA 126 and DACS 128.

But, in FIG. 1, two apparatus are illustrated and described separately in order to clarify the function of each apparatus.

The IWF 130 serves for enabling the user terminal 110 without an additional wireless modem to use wireless data communication service and connect to Internet or computer network.

That is, the IWF 130 serves for enabling the user terminal 110 to a server corresponding to a shopping mall domain entered by a buyer and transmitted from the user terminal 110.

The shopping mall server 140 is an apparatus for selling goods and services to a buyer, and examples thereof include an on-line shopping mall and the like.

The number domain information comprising a shopping mall code, a goods code and the like is opened to the public through a shopping mall site corresponding to the shopping mall server 140 or a television channel in order to be used by buyers.

The credit card company server 150 performs the authentication and payment for payment request information, when the payment request information is received from the shopping mall server 140.

In FIG. 1, only credit card company server 150 is illustrated, assuming that a buyer uses a credit card to pay for the goods. However, examples of payment methods may include, but not limited to, ARS payment, billing total service charge along with mobile communication service charge, CMS payment, payment using pre-paid card, and the like. The payment system can be applied depending on the payment method. But, a case that the payment method using the credit card company server 150 is employed will be described mainly.

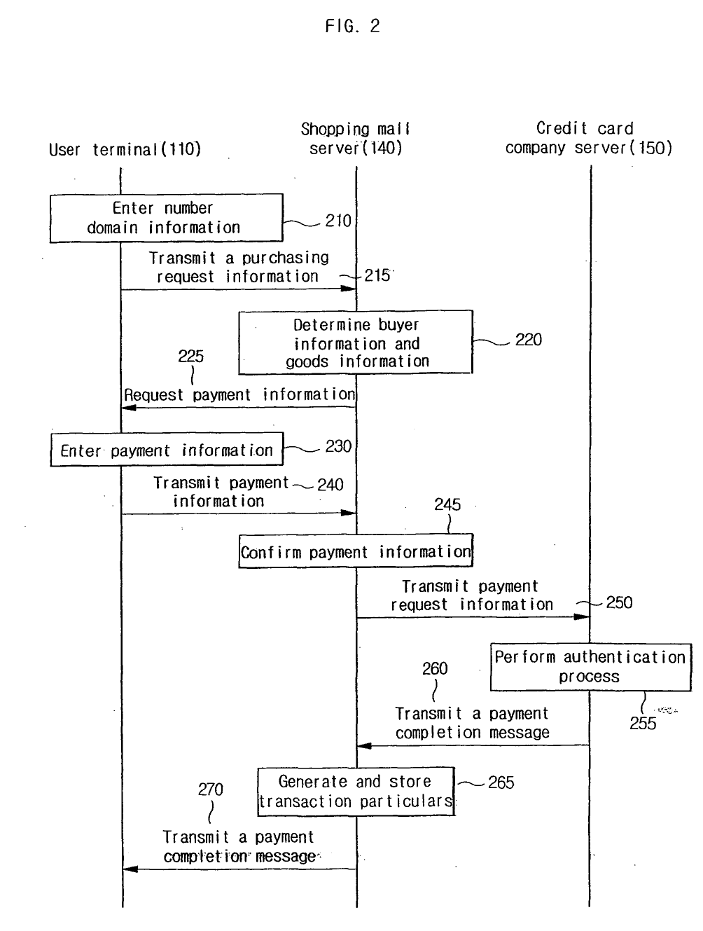

FIG. 2 illustrates a data flow for purchasing goods using a number based domain and the wireless Internet in accordance with one embodiment of the present invention.

In one embodiment, the system of FIG. 2 comprises a user terminal 110, a shopping mall server 140, a credit card company server 150 and the like, and further comprises a mobile telecommunication service system 120 or the like (not shown in this drawing).

The wireless data communication between the user terminal 110 and the shopping mall server 140 is executed through the mobile telecommunication service system 120. As illustrated in FIG. 1, the mobile telecommunication service system 120 may comprise a BTS 122, a MSC 124, a MSA 126, a DACS 128, an IWF 130 and the like.

The user terminal 110 is connected to the network managed by a mobile telecommunication service provider through the BTS 122 and the MSC 124, and can be connected to an Internet or PC communication network through the IWF 130 in the network.

That is, the interconnection, the transmission and reception of the data between the user terminal 110 and the shopping mall server 140 is conducted through several apparatus in the mobile telecommunication service system 120. However, the transmission and reception of the data between the user terminal 110 and the shopping mall server 140 is illustrated directly, not through the mobile telecommunication service system 120, in FIG. 2 in order to facilitate comprehension.

The buyer who desires to purchase goods enters number domain information with an input unit (e.g. a key pad or the like) of the user terminal 110 according to the format designated by the shopping mall company (step 210).

The number domain information may comprise a shopping mall code indicative of a kind of shopping mall, a goods code pre-determined according to goods and a seller code indicative of a kind of a company manufacturing goods or offering services.

The shopping mall server 140 provides examples comprising number domain information to be transmitted according to the designated format to the buyer through television channels or websites.

In addition, the shopping mall server 140 enables the buyer to acquire information relating to number domain information easily by providing functions of retrieving number domain lists and the like through a wired or wireless Internet site.

Further, an additional function capable of purchasing goods not only when a buyer finds number domain information corresponding to goods to be purchased during watching a television or web-surfing but also some time after can be included.

For example, a function for directly connecting to a shopping mall site using the pre-stored number domain information for purchasing goods if the buyer stores broadcasted number domain information in the user terminal 110 or a function for downloading transaction particulars to store in the user terminal 110 after the completion of the goods purchase process illustrated in FIG. 2 may be embodied.

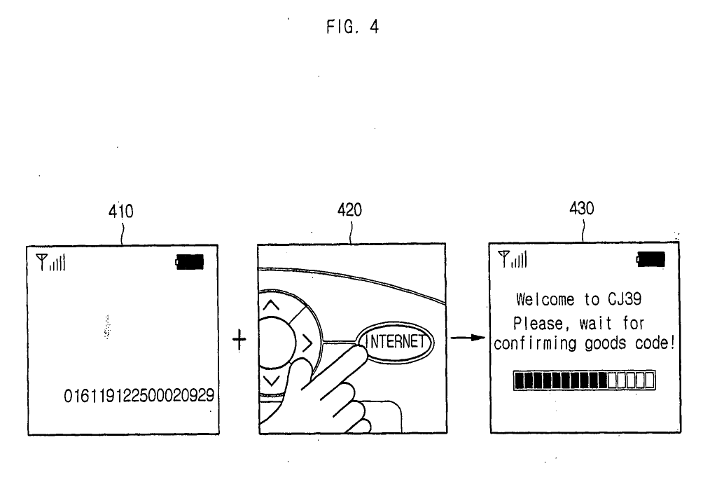

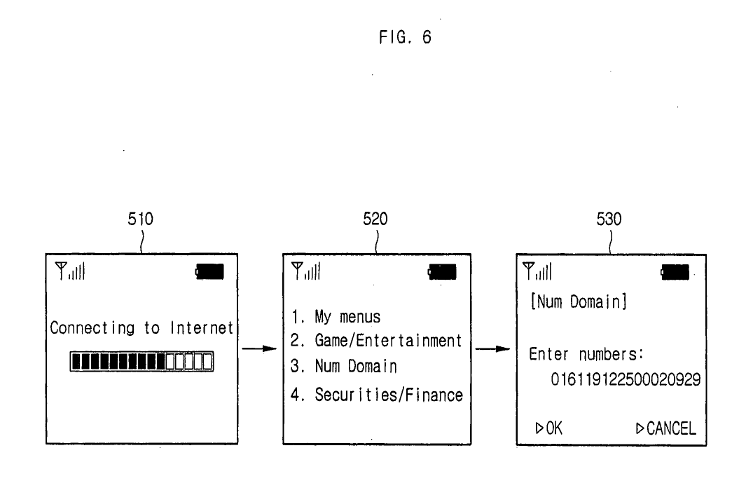

The step 210 can be embodied using the wireless number based domain function of the user terminal 110. The conventional user terminal executes the wireless number based domain function using the way of using hot key (see FIG. 4), the way of using menu (see FIG. 6) or the way of directly entering a domain address.

The user terminal 110 transmits the number domain information to MSA 126 in the mobile telecommunication service system 120, the MSA 126 transmits a purchasing request information generated from the received number domain information to the shopping mall server 140 (step 215). The purchasing request information may comprise a goods code extracted the number domain information, a seller code, a telephone number of the buyer and the like.

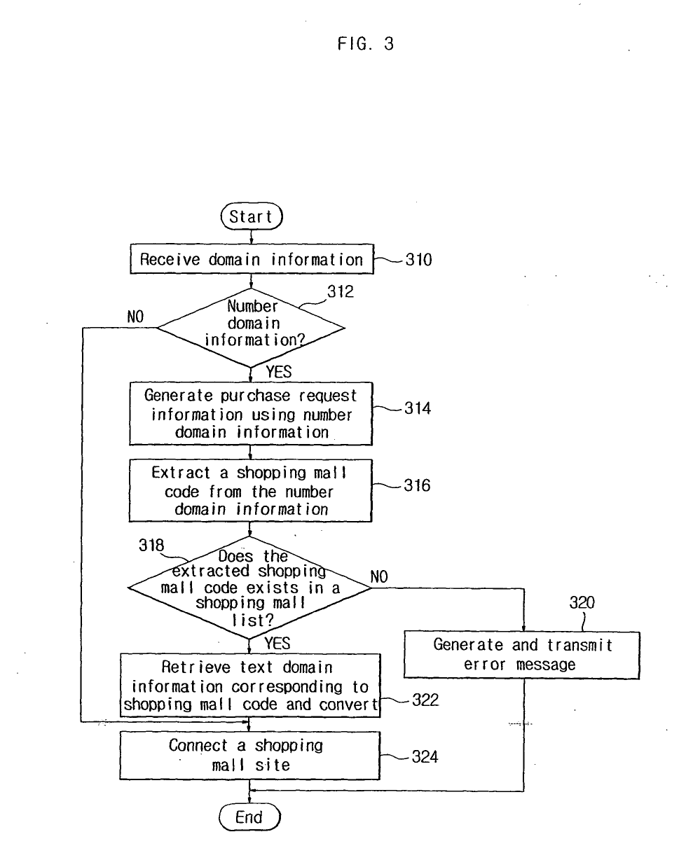

FIG. 2 is illustrated as if the user terminal 110 transmits the purchase request information to the shopping mall server 140 directly, because the mobile telecommunication service system 120 is omitted to make figure simple and clear. The operation of the mobile telecommunication service system 120 will be described in detail hereinafter with reference to FIG. 3.

At step 220, the shopping mall server 140 determines if the buyer information and the goods code, corresponding to the telephone number, the goods code and the seller code included in the received purchasing request information, are stored in database

If the buyer information is stored in the database, the shopping mall server 140 proceeds to step 225 because the buyer is a joiner of the shopping mall site.

For example, if the telephone number of the buyer is ‘011-222-3333’ and the goods code is ‘20929’, the shopping mall server 140 examines both whether a joiner having the telephone number ‘011-222-3333’ exists in a buyer list stored in the database and whether the goods corresponding to the goods code ‘20929’ exists in a goods list stored in the database.

In addition, the shopping mall server 140 confirms if the registered information of the joiner corresponding to the telephone number ‘011-222-3333’ is stored correctly. The registered information is for joining the shopping mall site as a joiner, and may comprises a name, an ID, a Password, a resident registration number, a credit card number for payment, a mobile phone number, a shipping address for delivering the purchased goods and the like.

If the buyer information is not stored in the database, the shopping mall server 140 transmits a purchase method selection display (see FIG. 8) or an error message to the user terminal 10 because the buyer is not a joiner of the shopping mall site or the goods code is entered incorrectly.

At step 225, the shopping mall server 140 transmits a payment information request display to the user terminal 110 through the mobile telecommunication service system 120.

The step which the shopping mall server 140 requests the payment information may be an authentication process prior to payment for purchasing goods, and the requested payment information may comprise a credit card number, a validity period, a password and the like.

At step 230, the buyer enters payment information corresponding to the payment information request transmitted from the shopping mall server 140 using the input unit (e.g. a keypad or the like) of the user terminal 110.

At step 240, the user terminal 110 transmits the entered payment information to the shopping mall server 140 through the mobile telecommunication service system 120. Encryption such as Secure Socket Layer (SSL) or the like is used to help to provide security before the payment information is transmitted in step 240.

At step 245, the shopping mall server 140 confirms the received payment information, proceeds to step 250 or transmits an error message to the user terminal 110. For example, if the buyer is a joiner and the credit card number received from the user terminal is the same as the credit card number stored in the database of the shopping mall server 140, it may proceed to step 250.

If the buyer is not a joiner, it directly proceeds to step 250 without the comparison process of two credit card numbers because the payment information of the buyer is not stored in the database of the shopping mall server 140.

At step 250, the shopping mall server 140 transmits payment request information corresponding to the goods requested for purchase to the credit card company 150. The payment request information may comprise a credit card number of the buyer, a validity period of the credit card, a password, a goods price of the goods requested for purchase and the like.

At step 255, the credit card company server 150 performs an authentication process for the buyer using the received payment request information and the pre-stored authentication information, and a payment process if the authentication process is performed successfully. For example, the credit card company server 150 can perform the authentication process by retrieving the credit card number of the buyer, a validity period and a password, and comparing those with the received information.

The credit card company server 150 performs the payment process, for example, using the method of withdrawing an amount of money for payment from an account for payment on a settlement day after generating transaction particulars and storing the transaction particulars.

The credit card company server 150 transmits a payment completion message to the shopping mall server 140 (step 260), the shopping mall server 140 generates transaction particulars corresponding to the purchased goods and stores the transaction particulars (step 265). The transaction particulars may comprise information for the buyer, the goods code requested for purchase, a seller code, an amount of money for payment and the like.

At step 270, the shopping mall server 140 transmits a transaction completion message to the user terminal 110.

Until now, however, only the method of using the credit card for payment for purchasing goods is described, several payment methods such as ARS payment, billing total service charge along with mobile communication service charge, CMS payment, payment using pre-paid card or the like can be further applied.

In case of being applied another payment method rather than the selected payment method in registering information (in aforementioned example, the payment method of using credit card corresponding to credit card number being entered for registering is applied), the shopping mall server 140 can request new payment information (step 225), receive the new payment information from the user terminal, and request payment to a payment system corresponding to the new payment information.

For example, when the payment method using additional credit card rather than a credit card being entered for registering, the shopping mall server 140 can request a new credit card number, a validity period, a password and the like to the user terminal 110 and request payment to additional credit card company server corresponding to the additional credit card.

In addition, when the payment method using billing total service charge along with mobile communication service charge is applied, the shopping mall server 140 can receive a telephone number for billing to the user terminal 110 (step 225) and then request payment to a billing system offering billing service corresponding to the telephone number. In this case, the billing system can perform the billing total service charge along with mobile communication service charge, and then report to the buyer.

FIG. 3 illustrates a flowchart for the operation executed by a domain address converting server and a mobile service apparatus in a goods purchase process using a number based domain and the wireless Internet in accordance with one embodiment of the present invention.

The operation of the DACS 128 and the MSA 126 in the mobile telecommunication service system 120 of FIG. 2 will be described in detail with reference to FIG. 3.

However the transmission and reception of data between each of the DACS 128 and the MSA 126 and the user terminal 110 is done through the BTS 122, the MSC 124 and the IWF 130, the case of assuming that the transmission and reception of data is done directly will be described in order to facilitate comprehension.

The MSA 126 receives domain information entered by a buyer from the user terminal 110 (step 310).

The MSA 126 examines whether or not the domain information is number domain information (step 312), and then it proceeds to step 314 if the domain information is identical to the number domain information.

When the received domain information is not suitable for the standard requirements for either text domain information (e.g., www.cjmall.co.kr) or number domain information, the process ends by regarding the domain information as a message incorrectly entered. It is needless to say that the MSA 126 connects to a shopping mall site in case that the received domain information is text domain information.

The MSA 126 generates purchase request information corresponding to the number domain information, and transmits the purchase request information to the DACS 128 (step 314). The purchase request information may comprise buyer information, a goods code extracted from the number domain information, a seller code and the like.

The MSA 126 can generate buyer information using the method of acquiring the telephone number by receiving the telephone number of the user terminal 110 transmitting the number domain information from the BTS 120 or retrieving the related information from a joiner database for mobile telecommunication service.

For example, if the telephone number ‘011-222-3333’ of the user terminal 110 transmitting the number domain information and the number domain information is ‘016119122500020929’, the purchase request information may be generated as ‘011222333300020929’ including ‘0112223333’ indicating the telephone number of the buyer, ‘000’ indicating the seller code and ‘20929’ indicating the goods code.

The DACS 128 extracts a shopping mall code from the number domain information by using the pre-determined method (step 316).

If a telephone number corresponding to a shopping mall is used as a shopping mall code, the digit numbers of the shopping mall code can be irregular according to the digit numbers of the telephone number (e.g. 10 digits in case of ‘016-119-1225’, 11 digits in case of ‘016-0119-1225’). In this case, the shopping mall code may be identified with the remaining digit numbers by extracting the fixed digit numbers corresponding to the seller code and the goods code from the total digit numbers on the basis of the last number rather than the first number.

In the aforementioned example, the remaining digit numbers with the exception of 8 digit numbers corresponding to the seller code and the goods code from the last number of the number domain information may be regarded as a shopping mall code, since the number domain information is consisted of a shopping mall code having 10 digits, a seller code having 3 digits and a goods code having 5 digits.

In addition, if an identifier (e.g., # or blank) is included in the number domain information to distinguish a shopping mall code, the shopping mall code can be extracted using the identifier in a shopping mall code extracting process.

For example, if number domain information is ‘0161191225#00020929’, it can extract ‘016119125’ prior to the identifier ‘#’ as a shopping mall code. And if the number domain information is ‘00020929#0161191225’, it extracts ‘016119125’ posterior to the identifier ‘#’ as a shopping mall code.

The DACS 128 determines whether the extracted shopping mall code exists in a shopping mall list stored in the database (step 318). According to the aforementioned example, the extracted shopping mall code is ‘0161191225’ generated by using the telephone number corresponding to the shopping mall, the DACS 128 examines whether the shopping mall code corresponding to ‘0161191225’ exists in the shopping mall list.

If the shopping mall code does not exist, the DACS 128 transmits an error message correspondingly generated to the MSA 126, and the MSA 126 transmits the received error message to the user terminal 110 (step 320). When the shopping mall code is entered incorrectly, it will fall into this case.

But, if the shopping mall code exists, the DACS 128 retrieves text domain information of a shopping mall site corresponding to the extracted shopping mall code, and then converts the number domain information into a text domain (e.g. domain in English or Korean) (step 322). For example, if the shopping mall code is ‘0161191225’, the shopping mall code is converted into ‘www.cjmall.co.kr’ as the text domain corresponding to ‘0161191225’.

The DACS 128 transmits the converted text domain information to MSA 126 (step 322).

The MAS 126 transmits the converted text domain information and purchase request information to the IWF 130 when the text domain information is received, and the IWF 130 lets the user terminal 110 connect a shopping mall site corresponding to the text domain in order that the shopping mall server 140 performs a goods purchase process correspondingly to the purchase request information (step 324).

FIG. 4 illustrates a screen display at a step of entering number domain information in a goods purchase process using a number based domain and the wireless Internet in accordance with one embodiment of the present invention.

FIG. 4 represents the screen display in case of the use of hot key among several wireless number based domain functions of the user terminal 110. The user terminal 110 includes hot key for directly connecting wireless Internet.

Referring to FIG. 4, number domain information comprises a shopping mall code (i.e. ‘0161191225), a seller code (i.e. ‘000’) and a goods code (i.e. ‘20929’).

That is, when a buyer connects to ‘CJ39 shopping’ and wants to buy a CD Player having a goods code ‘20929’ made by Samsung Electronics, the buyer enters ‘016119122500020929’ using the user terminal 110 (step 410), assuming that the shopping mall code corresponding to the ‘CJ39 shopping’ is ‘0161191225’, the seller code corresponding to Samsung Electronics is ‘000’, and the goods code corresponding to the CD Player is ‘20929’. And then, the buyer pushes a predetermined key of the user terminal 110 in order to connect to wireless Internet and request the purchase of the CD Player.

The shopping mall code may be the telephone number corresponding to a shopping mall offering shopping service or a unique code generated by the randomized combination of arbitrary numbers. The seller code and the goods code respectively may be a unique code predetermined by a shopping mall server 140.

The user terminal connects to the shopping mall server 140 offering the shopping service through a mobile telecommunication service system 110 (step 430).

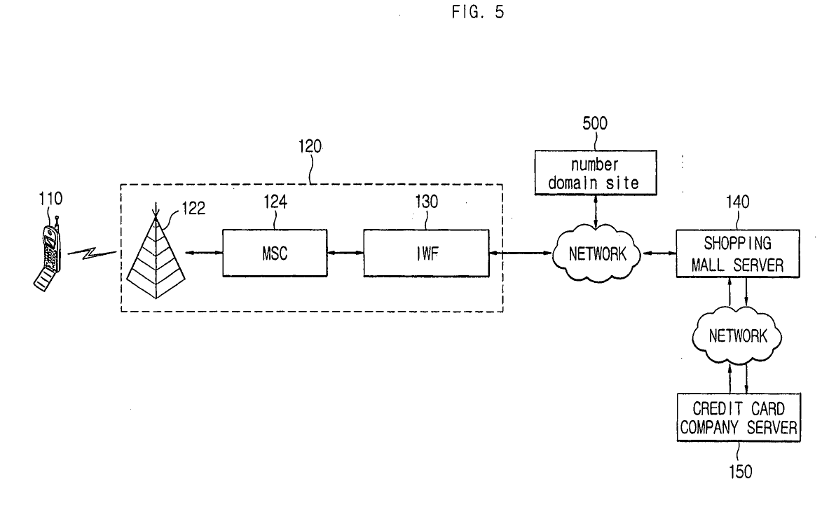

FIG. 5 is an entire schematic diagram of a system for executing a goods purchase process using a number based domain and the wireless Internet in accordance with another embodiment of the present invention.

FIG. 5 illustrates the system in case that a number domain site 500 performs the functions being performed by a MSA 126 and a DACS 128 included a mobile telecommunication service system 120 in FIG. 2.

The number domain site 500 is a site for providing wireless number based domain function. The number domain site 500 receives number domain information entered by a buyer through IWF 130, extracts a shopping mall code from the number domain information, and converts the shopping mall code into a text domain by retrieving it from the pre-stored domain list.

In addition, the number domain site 500 receives information corresponding to buyer information (e.g., by receiving a telephone number of the user terminal 110 transmitting the number domain information) from the mobile telecommunication service system 120, and generates purchase request information using the buyer information and the number domain information. The number domain site 500 transmits the purchase request information to the converted text domain address.

In the aforementioned case the number domain site 500 performs the functions of the MSA 126 and DACS 128. However, the purchase request information can be generated by the MSA 126 in the mobile telecommunication service system 120 when the number domain site 500 only performs the function of converting into text domain address as a role of the DACS 128.

In this case, the MSA 126 can generate the purchase request information using the received number domain information, transmit the number domain information to the number domain site 500, receive a text domain address corresponding to the number domain information, and transmit the purchase request information to the text domain address.

In FIG. 5, the each function of a mobile telecommunication service system 120, a shopping mall server 140 and a credit card company server 150 is the same as described with reference to FIG. 1.

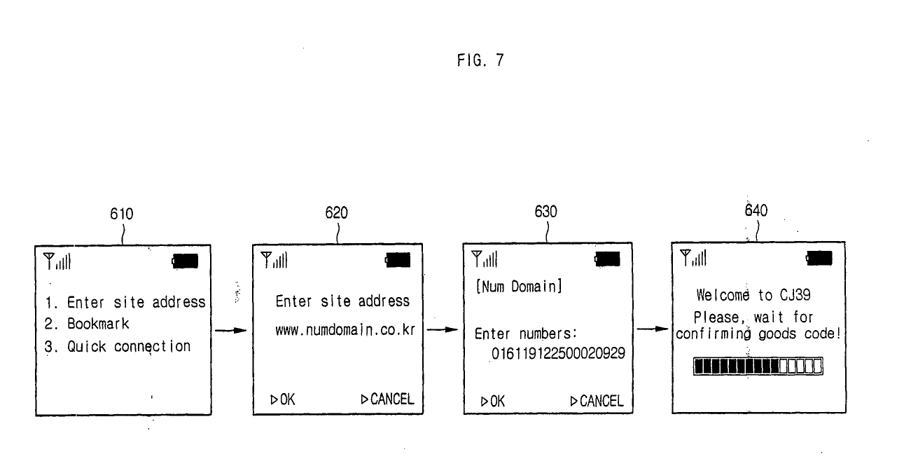

The screen display in case of a step of entering the number domain information is illustrated in FIG. 6 or FIG. 7.

FIG. 6 illustrates a screen display at the step of entering number domain information in a goods purchase process using number based domain and wireless Internet in accordance with another embodiment of the present invention.

FIG. 6 represents the screen display in case of the use of menu among several wireless number based domain functions of the user terminal 110. In this method, one-touch Internet service offered by the mobile telecommunication service system 120 can be applied, and examples of the one-touch Internet service include ‘NATE Service’ offered by SK telecom, ‘Magicn Service’ offered by KT Freetel, ‘EZ-Web Service’ offered by LG telecom, and the like.

The kind of the one-touch Internet service can be various according to the kind of the user terminal 110, the kind of the mobile telecommunication service system 120, use time and the like.

Referring to FIG. 6, the buyer connects to Internet using one-touch Internet service (step 510), and selects a menu for connecting a number domain site among one-touch Internet menus (step 520).

The number domain site is a site for providing a function of enabling the user terminal 110 to connect with the converted domain by converting number based domain information into a text domain when the number based domain information is received.

The user terminal 110 directly connects to a shopping mall site in FIG. 4. But, the method illustrated in FIG. 6 or FIG. 7 is connected to a shopping mall site through one-touch Internet or number domain site.

This is because embodiments illustrated in FIG. 4, FIG. 6 and FIG. 7 apply to the wireless number based domain functions of the conventional user terminal 110, respectively.

Continuing with reference to FIG. 6, the buyer connected to a number domain site connects a shopping mall site and purchases goods by entering the number domain information using the aforementioned method.

That is, if the kind of one-touch Internet is ‘NATE Service’, the text domain of the number domain site is ‘www.numdomain.co.kr’, and the shopping mall server offering shopping service is ‘CJ39 Shopping’, the user terminal 110 transmits a goods purchase request to ‘www.cjmall.co.kr’ corresponding to the ‘CJ39 shopping’ over the Nate service site and ‘www.numdomain.co.kr’.

FIG. 7 illustrates a screen display at a step of entering number domain information in a goods purchase process using a number based domain and the wireless Internet in accordance with still another embodiment of the present invention. The screen display in FIG. 7 represents the case of using the way of directly entering a domain address among several wireless number based domain functions.

Referring to FIG. 7, the buyer selects a menu for directly entering a domain address from menus offered by the user terminal 110 (step 610), enters an address (e.g., www.numdomain.co.kr) of a number domain site (step 620), and then enters number domain information.

When the buyer selects ‘OK’ button after entering the number domain information (step 630), the user terminal connects to a shopping mall server (e.g., a server corresponding to ‘www.cjmall.co.kr) offering shopping services through the mobile telecommunication service system 120 (step 640).

The format and the entry method of the number are same as described above.

FIG. 8 illustrates a screen display at a step of selecting purchase method in a goods purchase process using a number based domain and the wireless Internet in accordance with one embodiment of the present invention, and represents a screen display in case that the buyer information and the goods information do not exist or are stored incorrectly at step 220 in FIG. 2.

When that the buyer information and the goods information do not exist or are stored incorrectly, the shopping mall server 140 transmits a purchase method selection display to the user terminal 110 through the mobile telecommunication service system 120 (step 710).

If the buyer selects ‘purchase as a joiner’ menu, the shopping mall server 140 transmits a registration display shown in step 720. At step 720, the buyer has to enter registering information such as a name, an ID, a password, a resident registration number, a credit card number in order to register as a joiner. It is needless to say that additional information such as a shipping address for delivering the purchased goods and the like can be further included.

Now, the buyer may feel complication and inconvenience in a step of entering several information for registering, because the size of LCD of the conventional user terminal 110 is limited, the amount of wireless Internet content lacks and the structure of input unit included in the user terminal 110 does not convenient.

To solve the aforementioned problems associated with the conventional methods, the step 720 is performed such that it transmits text domain information rather than number domain information to the user terminal in order to be easily recognized, the buyer performs a registering process after connecting to a shopping mall site.

That is, a message such as ‘You can purchase after connecting to ‘www.cjmall.co.kr’ and registering as a joiner’ or the like can be transmitted to the user terminal.

If the buyer selects a ‘purchase as a guest’ menu, the shopping mall server 140 transmits payment information request display illustrated in step 730. Here, the requested payment information, as information requiring for payment for goods to be purchased, comprises a credit card number of the buyer, a validity period, a password and the like.

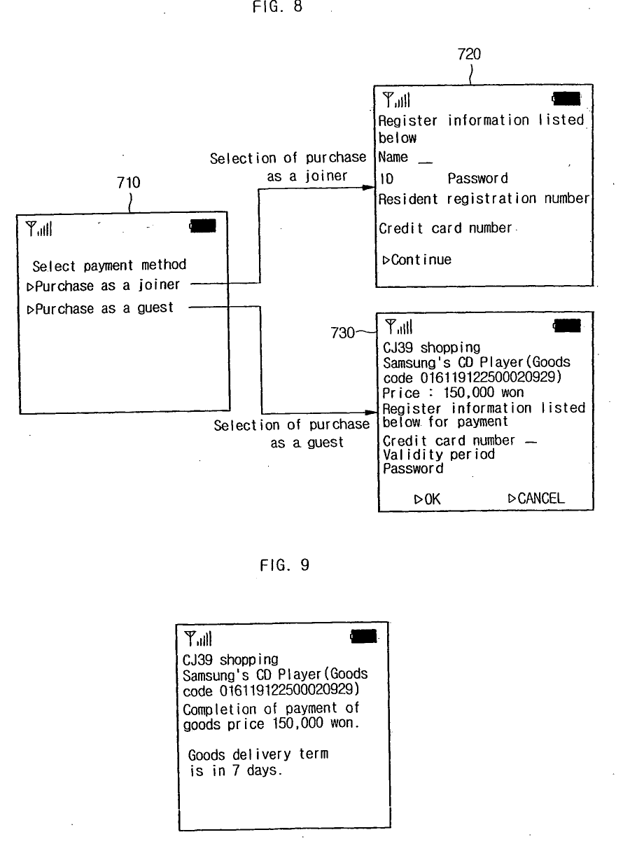

FIG. 9 illustrates a screen display at a step of receiving a payment completion message in a goods purchase process using a number based domain and the wireless Internet in accordance with one embodiment of the present invention, represents the screen display of the user terminal at step 270 in FIG. 2.

Referring to FIG. 9, the transaction completion message is a message for providing transaction particulars, may comprise a shopping mall code, a seller code and a goods code, and further comprise a good delivery term and the like.

In certain embodiments, it is possible to simplify the processes of connecting to a shopping mall site and selecting goods using a wireless number based domain function provided by a conventional user terminal without being provided an additional new system or new wireless content.

Further, it is possible to purchase goods securely by secure transmission of buyer's payment information.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A method of buying goods in a wireless telecommunication network, the method comprising:
receiving a numeric code associated with a retail transaction from a buyer terminal, wherein the numeric code comprises a shopping mall code corresponding to the website address of a shopping mall server and a goods code corresponding to goods to be purchased;
generating purchasing request information with the use of the numeric code, wherein the purchasing request information comprises the goods code and a telephone number of the buyer;
obtaining the shopping mall code from the numeric code;
determining whether or not the shopping mall code exists in a shopping mall list pre-stored in a database;
retrieving the website address of the shopping mall server when the shopping mall code exists in the shopping mall list; and
transmitting the purchasing request information to the shopping mall server based on the website address.

2. The method as stated in claim 1, further comprising interconnecting the shopping mall server and the buyer terminal via a network, in order that the buyer terminal is in data communication with the shopping mall server via the network.

3. The method as stated in claim 1, wherein the obtaining is performed by extracting at least one number data, in a predetermined field, as the shopping mall code.

4. The method as stated in claim 1, wherein the numeric code further includes a non-numeric identifier arranged between the shopping mall code and the goods code so as to separate the two codes, and wherein the obtaining is performed based on the identifier.

5. The method as stated in claim 1, wherein the numeric code is retrieved from the shopping mall website or downloaded to the buyer terminal.

6. The method as stated in claim 1, wherein the shopping mall server is configured to:
pre-store at least one goods information corresponding to at least one goods code;
receive the purchasing request information;
determine whether or not goods information corresponding to the goods code exists;
transmit, when the goods information corresponding to the goods code does not exist, a predetermined error message to the buyer terminal;
determine, when the goods information corresponding to the goods code exists, whether or not buyer information corresponding to the telephone number exists;
transmit, when the buyer information exists, payment request information to a first payment system corresponding to first payment information included in the buyer information, wherein the first payment information comprises at least one of the following: i) credit card information, ii) telephone number information for billing total service charge along with a mobile communication service charge, and iii) ARS billing information;
transmit, when the buyer information does not exist, payment information request to the buyer terminal;
receive second payment information corresponding to the payment information request from the buyer terminal; and
transmit payment request information to a second payment system corresponding to the second payment information.

7. The method as stated in claim 6, when the buyer information exists and the first payment information included in the buyer information is the credit card information, further comprising;
transmitting an entry request relating to at least one of a password and an expiration date corresponding to the credit card information to the buyer terminal; and
receiving the entry information relating to at least one of the password and the expiration date from the buyer terminal.

8. A system for buying goods in a wireless telecommunication network, the system comprising:
means for receiving a numeric code associated with a retail transaction from a buyer terminal, wherein the numeric code comprises at least a shopping mall code corresponding to the website address of a shopping mall server and a goods code corresponding to goods to be purchased;
means for generating purchasing request information from the numeric code wherein the purchasing request information comprises at least the goods code and a telephone number of the buyer;
means for obtaining the shopping mall code from the numeric code;
means for determining whether or not the shopping mall code exists in a shopping mall list pre-stored in a database;
means for retrieving the website address of the shopping mall server when the shopping mall code exists in the shopping mall list; and
means for transmitting the purchasing request information to the shopping mall server based on the website address.

9. The system as stated in claim 8, further comprising means for interconnecting the shopping mall server and the buyer terminal via a network, in order that the buyer terminal is in data communication with the shopping mall server via the network.

10. An apparatus for processing a purchase of goods in a wireless telecommunication network, the apparatus comprising:
a storage device; and
a processor coupled to the storage device,
wherein the storage device stores a program for controlling the processor; and
wherein the processor, being operative with the program, is configured to:
receive a numeric code associated with a retail transaction from a buyer terminal, wherein the numeric code comprises a shopping mall code corresponding to the website address of a shopping mall server and a goods code corresponding to goods to be purchased;
generate purchasing request information with the use of the numeric code, wherein the purchasing request information comprises the goods code and a telephone number of the buyer;
obtain the shopping mall code from the numeric code;
determine whether or not the shopping mall code exists in a shopping mall list pre-stored in a database;
retrieve the website address of the shopping mall server when the shopping mall code exists in the shopping mall list; and
transmit the purchasing request information to the shopping mall server based on the website address.

11. One or more processor readable storage devices having processor readable code embodied on the processor readable storage devices, the processor readable code for programming one or more processors to perform a method of buying goods in a wireless telecommunication network, the method comprising:
receiving a numeric code associated with a retail transaction from a buyer terminal, wherein the numeric code comprises a code corresponding to a website address of a server and a goods code associated with goods;
obtaining a telephone number of the buyer;
generating purchase request information which includes the goods code and the telephone number; and
transmitting the purchase request information to the server based on the code.

12. A method of buying goods in a wireless telecommunication network, the method comprising:
receiving a numeric code associated with a retail transaction from a buyer terminal, wherein the numeric code comprises a code corresponding to a website address of a server and a goods code associated with goods;
obtaining a telephone number of the buyer;
generating purchase request information which includes the goods code and the telephone number; and
transmitting the purchase request information to the server based on the code.

13. The method of claim 12, further comprising:
obtaining the code from the numeric code;
determining whether or not the code exists in a database; and
retrieving the website address of the server when the code exists in the database,
wherein the transmitting is performed based on the website address of the server.

14. The method of claim 12, wherein the numeric code further comprises at least one seller code.

15. The method of claim 12, wherein the method is performed in a mobile telecommunication service system.

16. The method of claim 12, wherein the numeric code further includes a non-numeric identifier arranged between the code and the goods code so as to separate the two codes.

17. The method of claim 12, wherein the buyer terminal includes at least one of the following: a portable computer, a mobile phone and a personal digital assistant.

18. A system for buying goods being in data communication with a buyer terminal and a server via a wireless telecommunication network, the system comprising:
a base transceiver station configured to receive a numeric code associated with a retail transaction from the buyer terminal, wherein the numeric code comprises a code corresponding to a website address of the server and a goods code associated with goods;
a processing unit configured to generate purchase request information which includes the goods code and a buyer's telephone number; and
an interworking function unit configured to transmit the purchase request information to the server based on the code.

19. The system of claim 18, wherein the processing unit comprises:
a mobile service apparatus configured to obtain the buyer's telephone number; and
a website address converting server configured to convert the code into the website address of the server,
wherein the interworking function unit is configured to transmit the purchase request information to the server based on the website address.

20. The system of claim 19, further comprising a mobile switching center configured to receive the numeric code from the base transceiver station and transmit the code to the mobile service apparatus.

21. The method of claim 4, wherein the identifier is either a predetermined mark or a predetermined character.
